(19) United States
(12) Patent Application Publication
(10) Pub. No.: US 2014/0314491 A1
(43) Pub. Date: Oct. 23, 2014

(54) MAINTENANCE METHODS USING MOTORIZED DILFLOATS ON SEISMIC STREAMERS

(71) Applicant: CGGVERITAS SERVICES SA, Massy Cedex (FR)

(72) Inventors: Jean-Michel FRAICHE, Montauban (FR); Gregory Mark PIKE, San Antonio, TX (US)

(73) Assignee: CGGVERITAS SERVICES SA, Massy Cedex (FR)

(21) Appl. No.: 13/868,165

(22) Filed: Apr. 23, 2013

(51) Int. Cl. G01V 1/38; B66D 3/20

(52) U.S. Cl. CPC G01V 1/3843; B66D 3/20
USPC 405/184.1

(57) ABSTRACT

Methods and systems allow for performing maintenance on a deployed portion of a seismic streamer. A method for raising and lowering a portion of a spread associated with a seismic streamer which is towed by a mother ship, the method including: configuring a device to be movable, wherein the device includes at least two buoyant structures connected by a platform, further wherein the platform includes a winch, a motor and controls associated with the winch and the motor; deploying the device from the mother ship overtop of the portion of the spread to be raised; lowering a line from the device via a winch to a position proximate the portion of the spread to be raised; connecting the line to the portion of the spread; and raising the line and the portion of the spread via the winch to a surface of a body of water.

### TECHNICAL FIELD

Embodiments of the subject matter disclosed herein generally relate to methods and systems associated with seismic surveying and, more particularly, to mechanisms and techniques for performing maintenance on seismic streamers.

### BACKGROUND

During the past years, the interest in developing new oil and gas production fields has dramatically increased. However, the availability of land-based production fields is limited. Thus, the industry has now extended drilling to offshore locations, which appear to hold a vast amount of fossil fuel. Offshore drilling is an expensive process. Thus, those engaged in such a costly undertaking invest substantially in geophysical surveys in order to more accurately decide where to drill in order to avoid a dry well.

Marine seismic data acquisition and processing generate a profile (image) of the geophysical structure (subsurface) under the seafloor. While this profile does not necessarily provide an accurate location for the oil and gas, it suggests, to those trained in the field, the presence or absence of oil and/or gas. Thus, providing a high resolution image of the subsurface is an ongoing process for the exploration of natural resources, including, among others, oil and/or gas.

During a seismic gathering process, as shown in FIG. 1, a vessel 10 drags an array of seismic detectors provided on streamers 12. The streamers may be disposed horizontally, i.e., lying at a constant depth relative to a surface 14 of the ocean. The vessel 10 also tows a seismic source assembly 16 that is configured to generate an acoustic wave 18. The acoustic wave 18 propagates downwards toward the seafloor 20 and penetrates the seafloor until eventually a reflecting structure 22 (reflector) reflects the acoustic wave. The reflected acoustic wave 24 propagates upwardly until the same is detected by detector 26.

The streamers 12 are shown in FIG. 2 spreading over a predetermined area. This is called the seismic spread. In order to maintain the plural streamers 12 substantially parallel and at equal distance from each other, various front-end gears are used. Streamers 12 are spread out to a desired width to provide measurements of the geological conditions over an acquisition area.

An example of a front-end gear 30 is shown in FIG. 2. The front-end gear 30 is provided between the vessel 10 and the various streamers 12 and this gear is configured to achieve the desired positioning for the streamer heads. FIG. 2 shows the front-end gear 30 to include cables 32 connected between the vessel 10 and deflectors 34. Deflector 34 is a structure capable of generating the necessary lift when towed to keep the streamers deployed in the transverse direction with respect to the sailing line of the towing vessel 10. Spacers 36 are attached to the cables 32 for distributing the lift force among them in order to obtain a substantially linear profile for the position of the streamer heads.

Considering the above described deployment examples, when deployed, the seismic streamer can be quite long in length, e.g., multiple kilometers, and heavy. Occasionally portions of the seismic streamer can fail in operation and need to be replaced. When a portion of the streamer, e.g., a streamer node/module or interface portion, fails it can be desirable to replace it as efficiently and safely as possible. One method for replacing a failed portion of the streamer is to fully recover the seismic streamer onboard the mother ship (streamer vessel). However, this is a slow procedure, e.g., 12-24 hours of downtime, which is inefficient and costly.

Another method for replacing a failed portion of the streamer is to send out a smaller boat, e.g., a work boat, from the mother ship. The work boat can position itself to retrieve a portion of the streamer in a location near the failed portion of the seismic streamer. As shown in FIG. 3, the people on the work boat 40 recover a portion of the seismic streamer 38 while having a replacement portion 42 ready for attachment. The portion of the seismic streamer 38 can be retrieved by first fishing for the seismic streamer 38. The failed portion 44 is also shown. A portion of the seismic streamer 38 can be then positioned on the work boat 40. The failed portion 44 is disconnected from the seismic streamer 38 and the replacement portion 42 is connected to the seismic streamer 38 as shown, for example, in FIG. 4.

However, if the portion of the seismic streamer 38 to be worked on is close enough to the spacers 36 which connect the streamers, it can be difficult, unsafe and in some cases not possible to utilize the method shown in FIGS. 3 and 4 for repairing the seismic streamer 38. When that occurs the only manner to repair the seismic streamer 38 is, as described above, to recover the entire streamer 38 by the mother ship which is time intensive and therefore costly.

Accordingly, it may be desirable to have systems and methods for improving the ability to perform maintenance on seismic streamers which have been deployed.

### SUMMARY

According to an exemplary embodiment, there is a maintenance method for raising and lowering a portion of a spread associated with a seismic streamer which is towed by a mother ship, the method including: configuring a device to be movable, wherein the device includes at least two buoyant structures connected by a platform, further wherein the platform includes a winch, a motor and controls associated with the winch and the motor; deploying the device from the mother ship; positioning the device launched from the mother ship overtop of the portion of the spread to be raised; lowering a line from the device via a winch to a position proximate the portion of the spread to be raised; connecting the line to the portion of the spread; raising the line and the portion of the spread via the winch to a surface of a body of water; and returning the device to the mother ship.

According to another exemplary embodiment, there is a method for performing maintenance on a portion of a spread associated with a seismic streamer which is towed by a mother ship, the method including: deploying a device from a mother ship, wherein the device includes at least two buoyant structures connected by a platform, further wherein the platform includes a winch, a motor and controls associated with the winch and the motor; configuring the device to be deployable for temporary situations; configuring the device to support maintenance operations on the portion of the spread; configuring the device to be moved by a work boat; positioning the device overtop of the portion of the spread to be raised for maintenance work; operating the winch to lower a line from the device to a position proximate the portion of the spread to be raised; configuring the line to be connected to the portion of the spread; configuring the motor to interact with the winch to raise the line and the portion of the spread to a surface of a body of water; and performing maintenance on the portion of the spread.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a conventional marine seismic acquisition configuration;

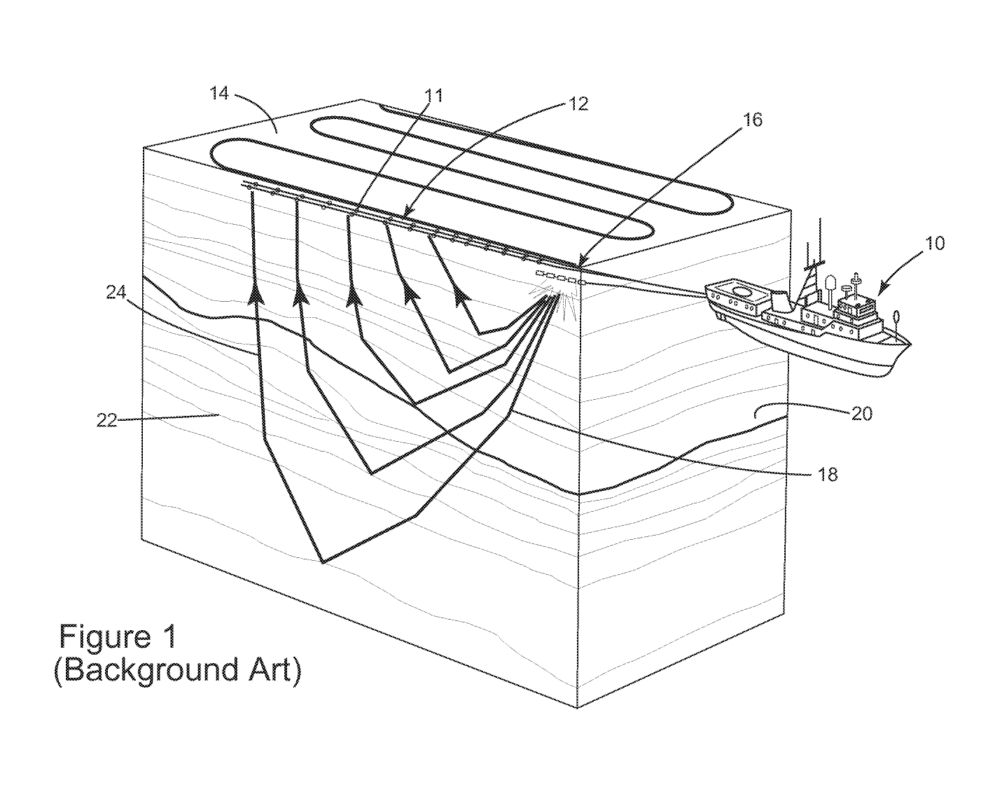

FIG. 2 is a schematic diagram of another conventional marine seismic acquisition configuration;

FIG. 3 depicts a portion of a conventional method for replacing a portion of a seismic streamer;

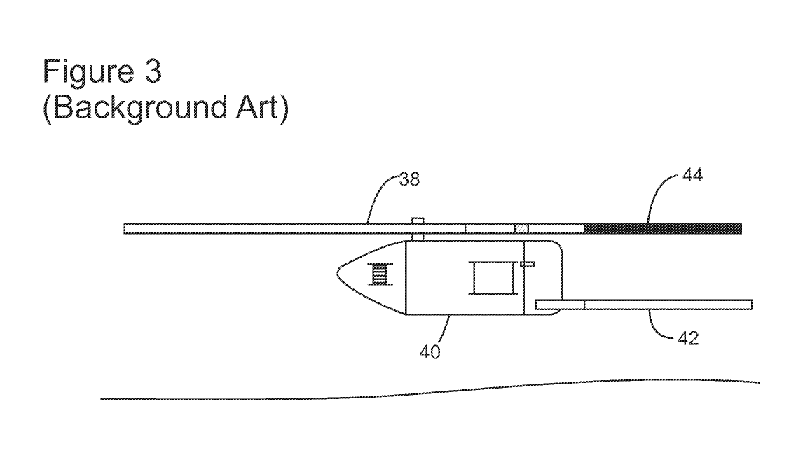

FIG. 4 shows another portion of a conventional method for replacing a portion of a seismic streamer;

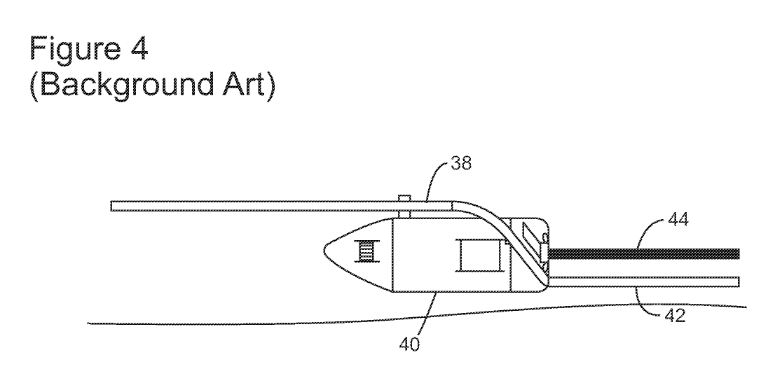

FIG. 5 illustrates a mother ship with a deployed streamer according to an exemplary embodiment;

FIG. 6 shows a platform with two floats for retrieving a portion of a seismic streamer according to an exemplary embodiment;

FIG. 7 depicts a portion of a retrieval method of a portion of a seismic streamer according to an exemplary embodiment;

FIG. 8 shows a float according to an exemplary embodiment;

FIG. 9 illustrates a method according to an exemplary embodiment; and

FIG. 10 illustrates another method according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a single seismic streamer. However, the embodiments to be discussed next are not limited to these structures, but may be applied to other structures that are towed, e.g., a plurality of seismic streamers.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to exemplary embodiments, it can be desirable to have methods and systems which are more efficient than conventional methods for performing maintenance on deployed seismic streamers, e.g., a towed cable or towed array which can include one or more hydrophones and other environmental sensors for determining environmental conditions such as water salinity and water temperature. Prior to describing these systems and methods, an environment in which these systems and methods can be used will first be described.

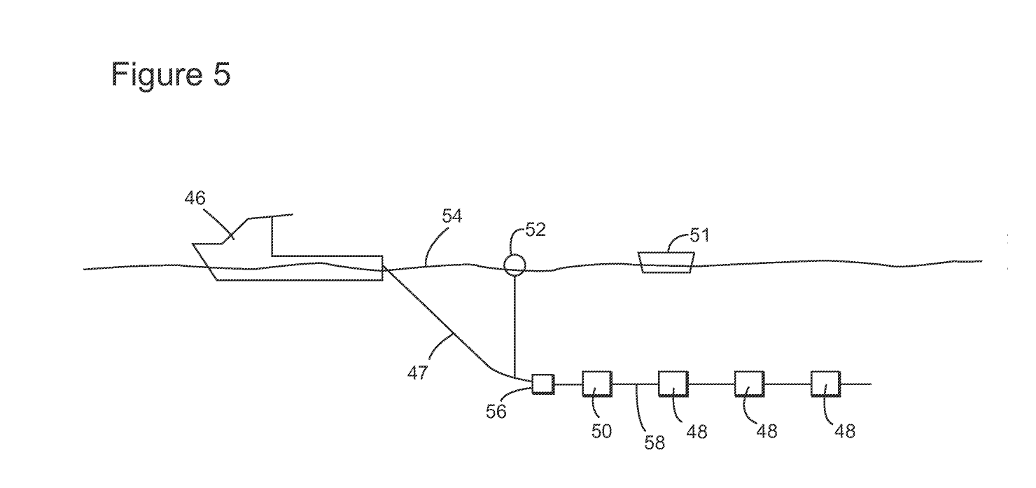

As shown in FIG. 5, there is a mother ship 46 which has deployed front end gear 47 attached to a seismic streamer 58 below the surface 54 of a body of water. While only one seismic streamer is shown here for simplicity, it is to be understood that more than one seismic streamer can be deployed. The seismic streamer 58 (which is also a portion of the spread) includes a plurality of sensors 48, including the front head module 50. The front head 50 can include one or more modules, such as a Line Acquisition Unit Marine or NAUTILUS Streamer Node, as well as other equipment as desired. The sensors 48 can be used in the acquisition of data, e.g., seismic data and/or environmental data. Attached to the seismic streamer 58 near the front head 50 is a front end connector 56 and a float 52 which is a permanent fixture of the deployed seismic streamer 58. Also, there is a front end connector 56 which connects the front end gear 47 to the seismic streamer 54. Additionally, a tail buoy (not shown) can also be used to support and/or guide the end of the streamer 58 which is distant from the mother ship 46.

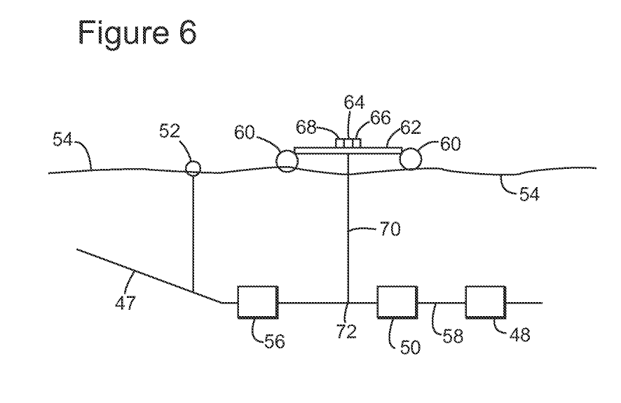

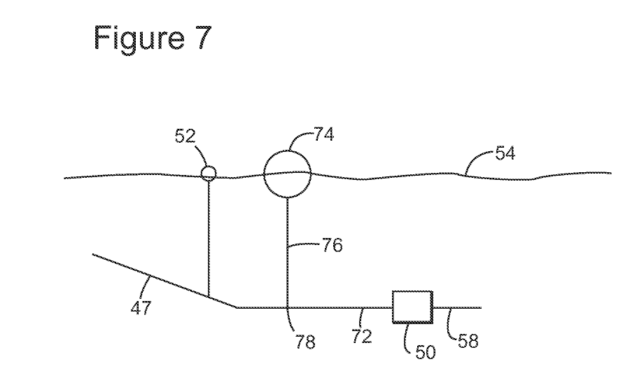

As described in the Background section, when maintenance work needs to be performed on the front head 50 or other gear associated with the front head 50, the seismic streamer 58 is typically retrieved, i.e., reeled back onto the mother ship 46, due to safety issues of working on the front head 50 from a work boat 51. According to exemplary embodiments, there are systems and methods which can be implemented for performing maintenance on the front head 50, or other portions of the seismic streamer 58, while the seismic streamer 58 is deployed, two initial configurations of which are described below and shown in FIGS. 6 and 7.

According to an exemplary embodiment, two floats 60 can be used in conjunction with a platform 62 to raise a portion of the seismic streamer 58 (or spread) to the surface 54 of the body of water as shown in FIG. 6. This platform 62 can be deployed by the mother ship 46 and delivered to a spot over top of the seismic streamer 58 by the work boat 51. FIG. 6 also shows the front head 50 and a connection point 72. Platform 62 includes a winch 64 with a line/chain 70 which can be raised and lowered. Additionally, there is a motor 66 associated with the winch 64 and a controls section 68 which can be operated remotely or locally.

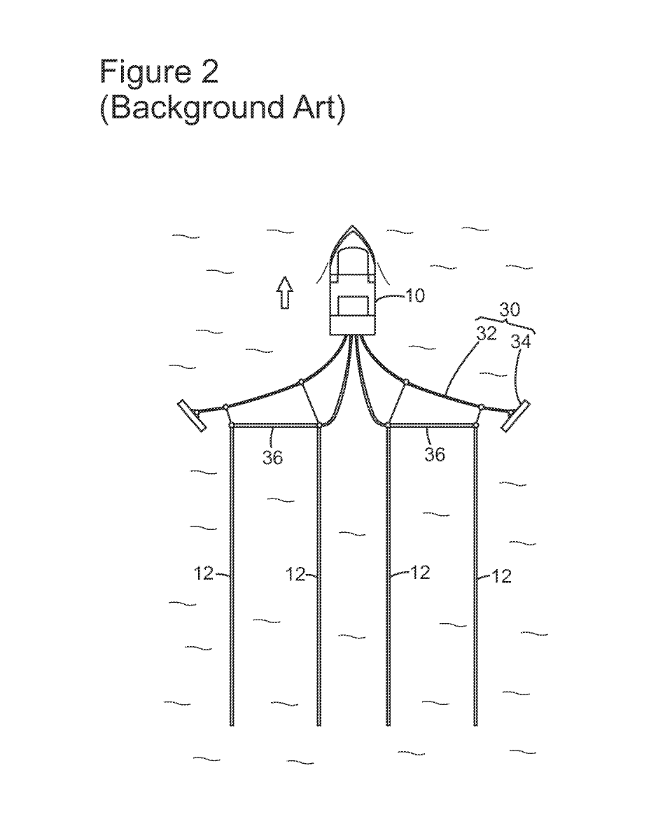

The two floats 60 are configured to be sufficiently buoyant enough and structurally sound to counter the high force level generated by lifting this portion of the seismic streamer 58, which required force is magnified by the relative closeness of the spacers between the various seismic streamers (see FIG. 2 for example). This buoyant platform 62 allows maintenance to be safely performed on the front head 50 (and other nearby sections) of the seismic streamer 48; which are individually and collectively referred to herein as head-end section(s). Maintenance, as used herein, can mean the replacement of a portion of the seismic streamer 58 as well as any other tasks performed for maintaining the support of continuing the operation of the seismic streamer 58.

The floats 60 can be Dilfloats, each of which is approximately three meters long with a 2000 liter volume, although embodiments are not limited to implementation with such Dilfloats. Once the portion of the seismic streamer 58 is on the surface 54 of the body of water, maintenance can then be performed using the workboat 51 as described in the Background section. Upon completion of the maintenance, the seismic streamer 58 can be lowered back to its original depth, and detached from the line 70. The platform 62 can then be returned to the mother ship 46 by the work boat 51. Additionally, while the connection point 72 is shown near the front head 50, the connection point 72 could be elsewhere on the seismic streamer 58 as desired.

According to another exemplary embodiment, another configuration can also be used as shown in FIG. 7. FIG. 7 shows a mobile, detachable float 74 which can be used in place of the platform 62 as described above with respect to FIG. 6. The mobile, detachable float can be deployed from the mother ship 46 and delivered to a spot over top of the seismic streamer 58, or spread, by the work boat 51. FIG. 6 also shows a line/chain 76 and a connection point 78. Once the portion of the seismic streamer 58 has been winched to the surface 54 of the body of water, maintenance can then be performed using the workboat 51 as described in the Background section. Upon completion of the maintenance, the seismic streamer 58 can be lowered back to its original depth, and detached from the line 76. The float 74 can then be returned to the mother ship 46 by the work boat 51. Additionally, while the connection point 78 is shown near the front head 50, the connection point 78 could be elsewhere on the seismic streamer 58 as desired.

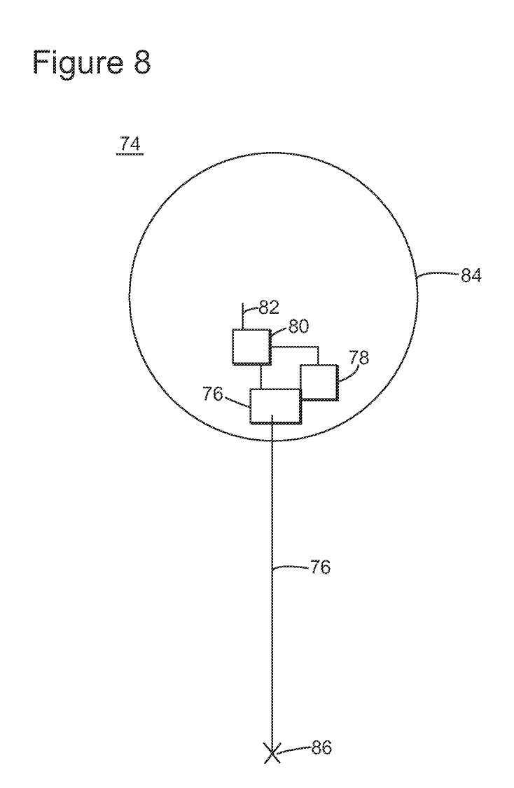

According to an exemplary embodiment, the float 74 will now be described in more detail. As shown in FIG. 8, the float 74 can include a winch section 76, a motor 78 (e.g., an electric motor), a control section 80 which can include an antenna 82, a shell 84 (e.g., an inflatable membrane and/or a plastic shell), a chain 76 (or other appropriately strong line/rope for the load to be lifted) and a connecting item 86 for connecting the chain 76 to the seismic streamer 58. There can also be a power supply (not shown) provided on the float 74 for the motor 78. The control section 80 can be remotely controlled by an operator on the work boat 51 using, for example, a wireless system for operating the winch section 76 and/or for other controls that may be added to the float 74 in support of the operation for raising/lowering the chain 76 and connecting the chain 76 to the seismic streamer 58.

The exemplary embodiments described above show raising a portion of the seismic streamer 58 near the front head 50. By using the systems and methods described herein, the down time of the seismic streamer 58 to replace a module in this section can be reduced from the current normal time, e.g., 12-24 hours, to as little as 20-30 minutes. This is a noticeable improvement in efficiency which can also allow for reduced operational costs. These embodiments also describe a device which may either be the float 74 or the platform 62 with multiple floats 64. This equipment may be stored on the mother ship 46 and deployed on an as needed basis.

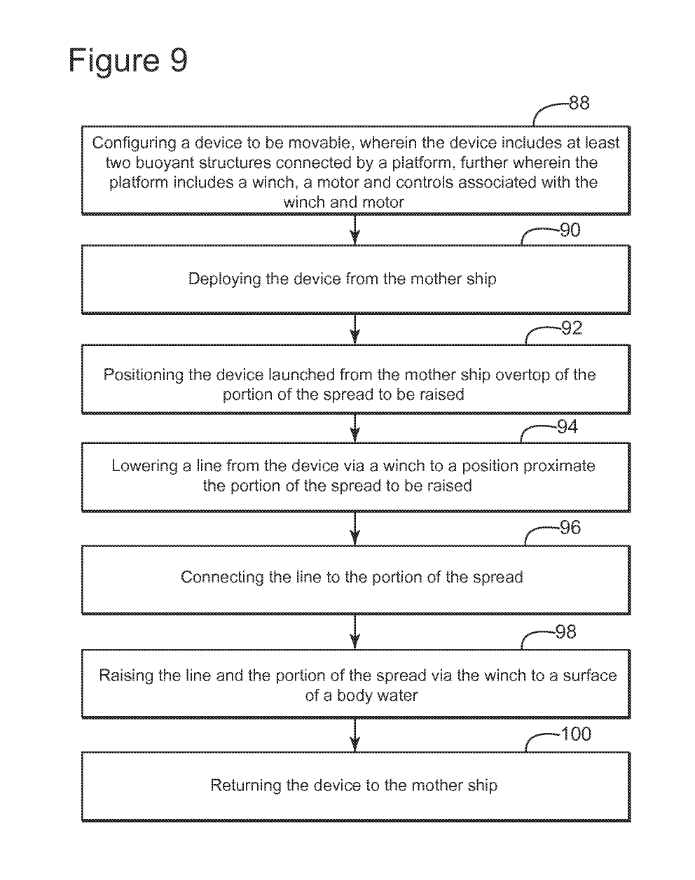

Utilizing the above described exemplary systems according to exemplary embodiments, a maintenance method for raising and lowering a portion of a seismic streamer is shown in the flowchart of FIG. 9. The method includes, at step 88, configuring a device to be movable, wherein the device includes at least two buoyant structures connected by a platform, further wherein the platform includes a winch, a motor and controls associated with the winch and the motor; at step 90, deploying the device from the mother ship; at step 92, positioning the device launched from the mother ship overtop of the portion of the spread to be raised; at step 94, lowering a line from the device via a winch to a position proximate the portion of the spread to be raised; at step 96, connecting the line to the portion of the spread; at step 98, raising the line and the portion of the spread via the winch to a surface of a body of water; and at step 100, returning the device to the mother ship.

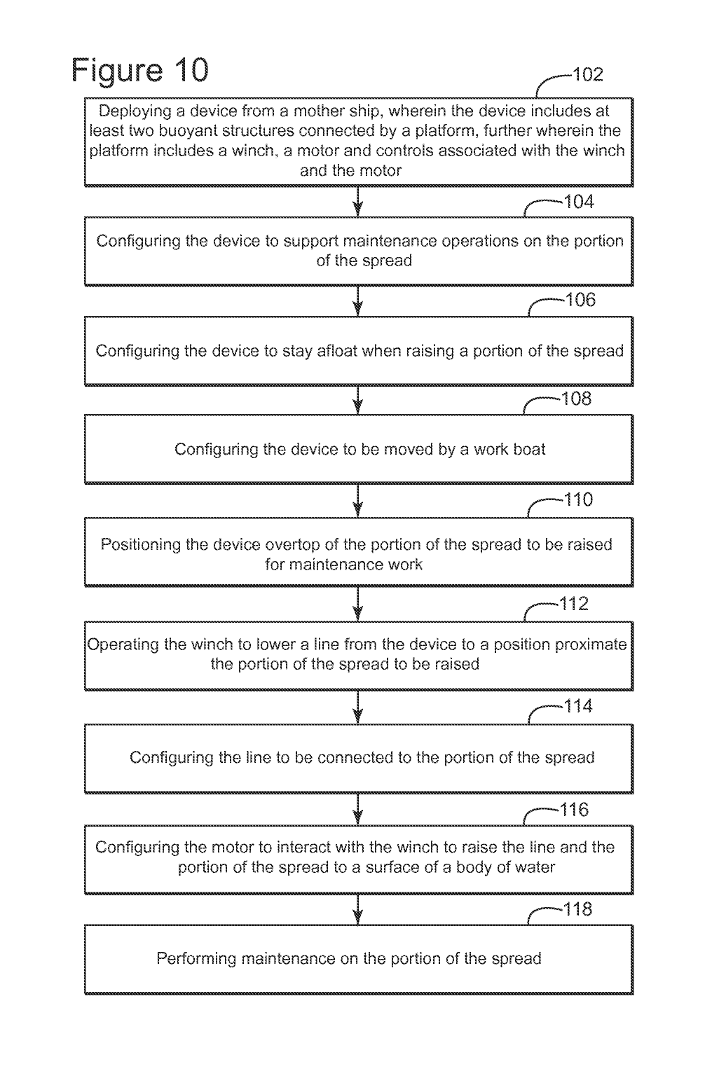

Utilizing the above described exemplary systems according to exemplary embodiments, a method for performing maintenance on a portion of a seismic streamer is shown in the flowchart of FIG. 10. The method includes, at step 102, deploying a device from a mother ship, wherein the device includes at least two buoyant structures connected by a platform, further wherein the platform includes a winch, a motor and controls associated with the winch and the motor; at step 104, configuring the device to stay afloat when raising a portion of the spread; at step 106, configuring the device to support maintenance operations on the portion of the spread; at step 108, configuring the device to be moved by a work boat; at step 110, positioning the device overtop of the portion of the spread to be raised for maintenance work; at step 112, operating the winch to lower a line from the device to a position proximate the portion of the spread to be raised; at step 114 configuring the line to be connected to the portion of the spread; at step 116, configuring the motor to interact with the winch to raise the line and the portion of the spread to a surface of a body of water; and at step 118 performing maintenance on the portion of the spread.

The disclosed exemplary embodiments provide a system and a method for towing an array of streamers underwater. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A maintenance method for raising and lowering a portion of a spread associated with a seismic streamer which is towed by a mother ship, the method comprising:
configuring a device to be movable, wherein the device includes at least two buoyant structures connected by a platform, further wherein the platform includes a winch, a motor and controls associated with the winch and the motor;
deploying the device from the mother ship;
positioning the device launched from the mother ship overtop of the portion of the spread to be raised;
lowering a line from the device via a winch to a position proximate the portion of the spread to be raised;
connecting the line to the portion of the spread;
raising the line and the portion of the spread via the winch to a surface of a body of water; and
returning the device to the mother ship.

2. The method of claim 1, further comprising:
performing maintenance on the spread;
lowering the line and the portion of the spread via the winch to a position under the surface of the body of water; and
retrieving the device by a work boat.

3. The method of claim 2, wherein the step of performing maintenance on the spread is performed by a crew of the work boat.

4. The method of claim 3, wherein the steps of performing lowering the line, retrieving the device and returning the device are performed after the step of performing maintenance on the spread.

5. The method of claim 1, wherein the device is configured to stay afloat when raising a portion of the spread.

6. The method of claim 1, further comprising:
configuring the device to be movable, wherein the device is a buoyant structure which includes a winch, a motor and controls.

7. The method of claim 6, wherein the device is configured to stay afloat when raising the portion of the spread.

8. A method for performing maintenance on a portion of a spread associated with a seismic streamer which is towed by a mother ship, the method comprising:
deploying a device from a mother ship, wherein the device includes at least two buoyant structures connected by a platform, further wherein the platform includes a winch, a motor and controls associated with the winch and the motor;
configuring the device to support maintenance operations on the portion of the spread;
configuring the device to stay afloat when raising a portion of the spread;
configuring the device to be moved by a work boat;
positioning the device overtop of the portion of the spread to be raised for maintenance work;
operating the winch to lower a line from the device to a position proximate the portion of the spread to be raised;
configuring the line to be connected to the portion of the spread;
configuring the motor to interact with the winch to raise the line and the portion of the spread to a surface of a body of water; and
performing maintenance on the portion of the spread.

9. The method for performing maintenance of claim 8, further comprising:
configuring the controls to allow the device to be operated either remotely or locally.

10. The method of claim 8, further comprising:
returning the device to the mother ship by the work boat after maintenance on the portion of the spread has been performed.

11. A maintenance method for raising and lowering a portion of a spread associated with a seismic streamer which is towed by a mother ship, the method comprising:
configuring a device to be movable, wherein the device includes a buoyant structure carrying a winch, a motor and controls associated with the winch and the motor;
deploying the device from the mother ship;
positioning the device launched from the mother ship overtop of the portion of the spread to be raised;
lowering a line from the device via a winch to a position proximate the portion of the spread to be raised;
connecting the line to the portion of the spread;
raising the line and the portion of the spread via the winch to a surface of a body of water; and
returning the device to the mother ship.
